(19) United States
(12) Patent Application Publication
(10) Pub. No.: US 2010/0315836 A1
(43) Pub. Date: Dec. 16, 2010

(54) Flat panel optical display system with highly controlled output

(76) Inventor: Brian Edward Richardson, Campbell, CA (US)

Correspondence Address: CARR & FERRELL LLP, 120 CONSTITUTION DRIVE, MENLO PARK, CA, 94025, US

(21) Appl. No.: 12/456,122

(22) Filed: Jun. 11, 2009

(51) Int. Cl. F21V 8/00

(52) U.S. Cl. 362/619; 362/97.2

(57) ABSTRACT

A brightness enhancing reflector to accurately control the light exiting the guide achieves accurate control of the reflected light by extracting light from a limited area of the light guide. The configuration of the reflectors used for the selective extraction determines the nature of the output light. The reflectors are preferably located on a side of the light guide opposite to an output side of the light guide and in conjunction with an electronic display.

### FIELD OF THE INVENTION

This invention relates generally to LCD type displays, and more particularly is an optical system with a light guide to control the direction in which light travels through a display for better viewing and efficiency.

### BACKGROUND OF THE INVENTION

Many products require an optical system to spread light over a large area and to control the direction of the light exiting the system. Recent improvements in the performance of LEDs, coupled with a concurrent reduction in the cost of production, have made LEDs a more viable option for many applications. However, many applications, such as LCD backlights, signs with backlights, overhead lighting, and automotive lighting, require the concentrated light that is generated by an LED to be spread over a relatively large area, while still controlling the direction of the light. These applications require an improved optic system to provide the desired light control.

Displays based on LCD technology have also been evolving for decades. However, current art displays still have several shortcomings. The chief shortcoming of many of the current art devices is excessive energy consumption. A 65″ diagonal HDTV LCD TV typically draws around a half of a kilowatt. This is a result of the poor efficiency of the current technology.

One way to improve the efficiency of LCD displays is to direct as much of the available light as possible from the light source toward the area most easily seen by the viewer. With a hand held display device, where power consumption is clearly an important consideration, a narrowly angled light directed towards the viewer is desired.

In a standing application, such as a TV, it is desirable to have the highest intensity segment of the light projected in a direction normal to the surface of the display. It is also important to provide a significant amount of light to the left and right of normal. This is required for viewers that are not in the optimal (normal to the screen) viewing position. It is also desirable in these standing applications to reduce the amount of light that is projected above and below the angle normal to the screen. If the light that is typically directed in the off normal directions is re-directed to the preferred angles, the intensity of the light transmitted in the preferred directions is increased.

Three groups of prior art references have addressed the control of light in LCD type displays. The most common class of references is the prism type “brightness enhancing film” (BEF) device. One example of a BEF device is U.S. Pat. No. 5,467,208, “Liquid Crystal Display” by Shozo Kokawa, et al., issued Nov. 14, 1995. This reference discusses the prior art of prism type films and discloses improvements to the art. One drawback to prism films is that they have only limited control of the angles of the light output. Changes to the prism features result in only slight variations in the light output. The prism films are also limited to a two dimensional structure. If an application requires control of the light in more than one direction, multiple BEFs must be deployed.

FIG. 1 illustrates a typical architecture of an LCD display with a prism type BEF film. An LCD display 1 is shown with the backlight components exploded. An LCD cell 2 is comprised of a number of subcomponents (not exploded in this view). The subcomponents include, but are not limited to, polarizing filters, glass substrates, liquid crystal, electronics, and color filters. Behind the LCD cell 2 are two prism films 3 and 4. These films redirect light towards the viewer. The next component in the display 1 is a diffusion film 5. A light guide 6 conducts light from LEDs 7 and allows the light to exit evenly so that the light intensity seen by the viewer is even over the entire display area. The last component in the display 1 is a reflector 8. The reflector 8 redirects light from the light guide 6 that is projected in a direction opposite to that desired, toward the LCD cell 2 and to the viewer.

Referring next to FIG. 2, a magnified close-up of the LCD cell 2 is shown from the perspective that a viewer would view the display. An opaque area 10 forms a matrix around a blue color filter 11, a green color filter 12, and a red color filter 13. The color filters 11, 12, 13 are typically rectangular shaped. The matrix area 10 is typically black to hide the electronics used to drive the display. With a prism film, the matrix area 10 absorbs a significant portion of the light that would otherwise pass through the display. This absorption can be as high as 50% of the total amount of light being received into the LCD cell. It is an object of the present invention to eliminate the effect of a significant portion of the black matrix to increase the brightness seen by the viewer.

Referring now again to FIG. 1, the LCD cell 2 includes polarizing filters on its front and rear surfaces. To create good contrast ratios with the display, the polarizing filters must be of high quality. Contrast is highest when the display is viewed from an angle normal to the display surface. Off axis contrast ratio performance degrades quickly the farther the viewer is removed from normal. The lowering of viewed contrast is an inherent characteristic of displays using polarizing filters. The contrast ratio is further reduced by the liquid material technology used in the LCD cell 2. It is another object of the present invention to increase the contrast in the off normal viewing positions.

A second class of prior art is exemplified by U.S. Pat. No. 6,421,103, “Liquid Crystal Display Apparatus . . . ” by Akira Yamaguchi, issued Jul. 16, 2002. The Yamaguchi reference discloses another type of device used to control light as it enters an LCD panel. The Yamaguchi patent discloses light sources, a substrate (not used as a light guide), apertures, and reflective regions on the substrate. The light is either reflected by the reflective surface or passes through the apertures. The light that passes through the apertures is captured by a lens used to control the direction of the light. Yamaguchi teaches restriction of the angle of the output light to concentrate more light directly at the viewer of an LCD type display. The Yamaguchi device provides much greater control of the output light than can be had with a BEF device. But a drawback to the Yamaguchi device is that it is extremely inefficient. Light must reflect off of the reflective surface many times before it exits the aperture. Even when the reflective surface is made with a high reflectance material, the losses in intensity are substantial. Therefore while the control of light with a Yamaguchi type device is superior to that of BEF devices, the efficiency of the device is much poorer.

U.S. Pat. No. 5,396,350, “Backlighting Apparatus . . . ” by Karl Beeson, issued Mar. 7, 1995; and U.S. Pat. No. 7,345,824, “Light Collimating Device” by Neil Lubart, issued Mar. 18, 2008; disclose devices in the third class of light control optics for LED light source devices. The Beeson and Lubart references disclose a reflective structure on the side of the light guide. The range of control of these reflective structures is limited, and is not equivalent to the control afforded by devices such as Yamaguchi. Further, the reflective structures are positioned very close to the LCD panel, which allows defects in their output to be easily seen by the viewer of the display.

In view of the shortcomings of the prior art discussed above, it is an object of the present invention to provide an optical display system with a light guide that is extremely efficient.

It is another object of the present invention to provide a less complex light guide, thereby reducing the cost of manufacturing.

It is another object of the present invention to improve the off axis contrast ratio of the display system.

It is a further object of the present invention to avoid the electronics black matrix.

It is still another object of the present invention to provide a light guide that will provide extremely accurate control of the direction of light output.

### SUMMARY OF THE INVENTION

The present invention is an optic system for a light guide that precisely controls the angle of the light as it exits the system. The system will typically be utilized with LCD displays such as those used in cellular phones, laptop computers, computer monitors, TVs, and commercial displays. The system provides for light to be extracted from the light guide at discrete points. Using extraction elements in combination with a reflector, the output light of the system can be controlled to be parallel, divergent, or convergent. The light can also be focused between the black matrix areas of the LCD cell.

Enabling technology for display systems that utilize light guides with selective extraction means is disclosed in Applicant's co-pending applications Ser. No. 12/319,171, and Ser. No. 12/319,172, both filed Jan. 2, 2009, and which are hereby incorporated by reference into the present application.

An advantage of the optic system of the present invention is that the system accurately controls the angles of the output light.

Another advantage of the optic system of the present invention is that the system transmits light more efficiently than prior art devices.

Yet another advantage of optic system of the present invention is that the system is simple in construction, and is therefore easy and economical to manufacture.

Still another advantage of the optics system of the present invention is that the black matrix within the LCD cell is avoided to increase the brightness of the output light.

These and other objects and advantages of the present invention will become apparent to those skilled in the art in view of the description of the best presently known mode of carrying out the invention as described herein and as illustrated in the drawings.

### BRIEF DESCRIPTION OF THE DRAWINGS

FIG. 1 is an exploded perspective view of a prior art device for LCD backlighting.

FIG. 2 is a magnified view of a prior art LCD display.

FIG. 3 is an exploded perspective view of the optics system of the present invention.

FIG. 4 shows only the light guide and LEDs of the optics system.

FIG. 5 is a partial, magnified side section view of the light source end of the optics system.

FIG. 6 is a magnified view of a small section of the optics system shown in FIG. 5.

FIG. 7 is an even further magnified view of a small section of the optics system shown in FIG. 6.

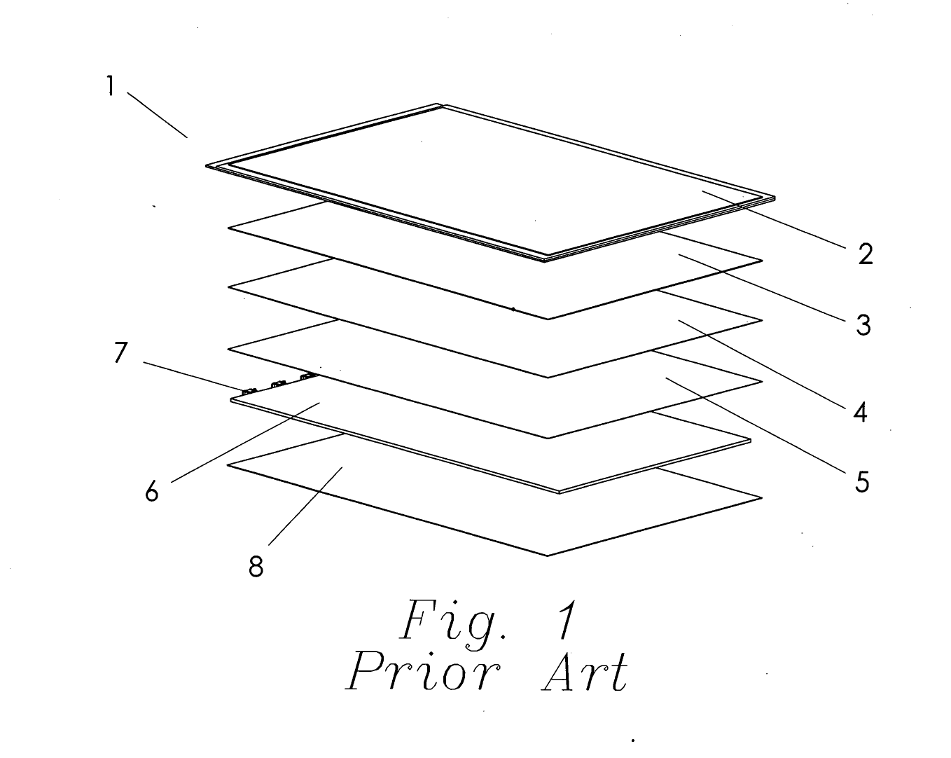

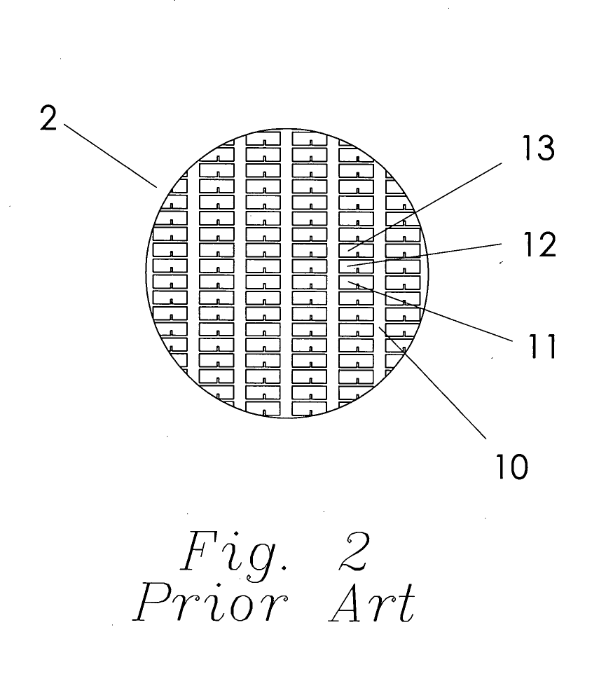

### DETAILED DESCRIPTION OF THE INVENTION

This description will refer first to FIG. 3, which shows an exploded view of the present invention, an LCD display assembly 20. The display assembly 20 comprises a light guide 21 which encompasses a planer area generally equivalent to that of the overall LCD display 20. As illustrated, the light guide 21 decreases in thickness from a relatively thick light source end to a significantly thinner distal end. It should be noted that the actual geometric configuration of the light guide 21 may vary depending on an intended application of the display. It should also be noted that the taper of the light guide 21 may be linear, curved, or quadratic in nature. One skilled in the art of light guides could configure the light guide in many ways while retaining the teaching of the present invention. In addition to the many variations of curvature contemplated by the present invention, the light guide 21 could also be made with a uniform thickness along its entire length.

The light sources, LEDs 22, are mounted in the preferred embodiment on a front edge of the thick end of the light guide 21. The surfaces of the LEDs 22 that emit light are in close proximity to the outer edge of the light guide 21. The number and colors of the LEDs 22 and the side of the light guide 21 where the LEDs 22 are located would be a function of the size, shape, and application of the display system 20. The LEDs 22 require electronics to drive them at the proper levels, and a person knowledgeable in LED driver electronics can devise many different circuits to accomplish this task. The preferred embodiment of the display system 20 illustrated in FIG. 3 comprises a total of six LEDs 22 shown generally equally spaced along the thick end of the light guide 21. It should be recognized that other types of light sources such as incandescent or fluorescent lights could also be used as the light source for the light guide 21.

The light guide 21 is secured on or near a bottom side of an LCD cell 23. For clarity of illustration, the light guide 21 is shown in FIG. 3 as removed from the LCD cell 23. In normal applications, there would typically be only a very small gap between light guide 21 and the LCD cell 23. In fact, the light guide 21 and the LCD cell 23 may be glued together with a low index adhesive if desired. In the preferred embodiment of the invention, a diffusion filter 24 is positioned on a top side of the LCD cell 23. Typically, the diffusion filter 24 is glued to the LCD cell 23 with adhesive.

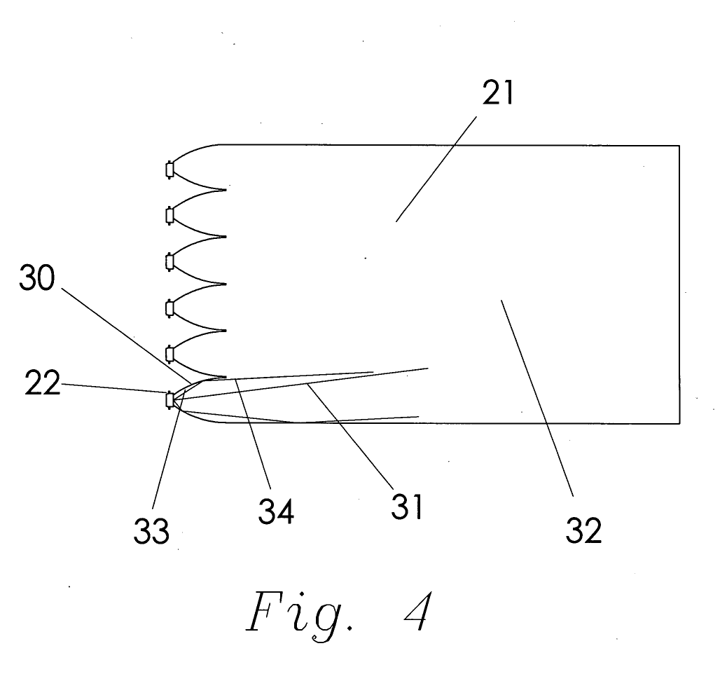

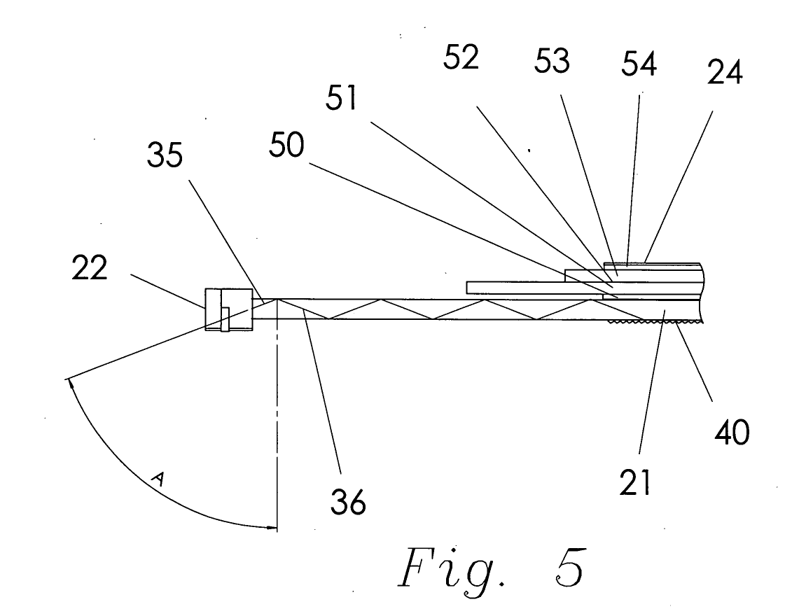

FIG. 4 shows the light guide 21, the light source LEDs 22, and a plurality of side reflector edges 30 of a front end of the light guide 21. The side reflector edges 30 are provided in order to direct a larger percentage of the light generated by the LEDs 22 to travel within the light guide 21 in a direction substantially normal to a front edge of the light guide 21. Looking at the side reflector edges 30 from the mounting points of the LEDs 22, the side reflector edges 30 have a curved or angled reverse taper pattern. The side reflector edges 30 expand from a plurality of narrow LED mounting points that are separated from each other and taper outward until the reflector edges 30 combine to form a front end of a main body of the light guide 21. The tapered shape of the side reflector edges 30 allows more of the light generated by the LEDs 22 to be directed into the light guide 21 in a direction substantially normal to a front edge of the light guide 21. In practice, the side reflector edges 30 are cut into the light guide 21 when the main body of the light guide 21 is being fabricated.

As illustrated in FIG. 4, light generated by the LEDs 22 travels at a variety of angles. FIG. 4 shows a sampling of both shallow angle light rays 31 and wide angle light rays 33 generated from the LEDs 22. The shallow angle light rays 31 are not affected by the side reflector edges 30, as they travel directly from the LEDs 22 to the main panel area 32 of the light guide 21. The wide angle light rays 33 contact the higher index area of the side reflector edges 30 of the light guide 21. The side reflector edges 30 reflect the wide angle light rays 33 to a shallower angle from normal, so that the wide angle light rays 33 are also directed to the main panel area 32 of the light guide 21. The effect of the reduction in angle of the wide angle light rays 33 is ultimately realized by polarizing filters of the LCD cell 23. The effect of the reduction in angle of the light rays 33 will be discussed in greater detail below.

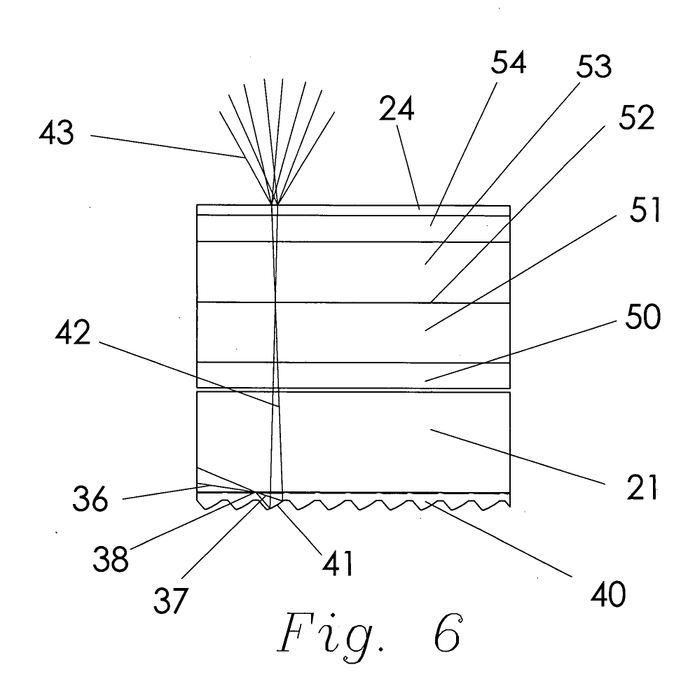

FIG. 5 shows a side view of a representative light ray 35 traveling in the interior of the light guide 21. The light ray 35 eventually impacts the surface of the light guide 21. When the contact angle of light ray 35 with the surface of the light guide 21 is shallow, the light reflects off of the surface of the light guide 21. This reflection is governed by the equation:

A=arcsine(Ns/Nlg)
Where Nlg is the index of refraction of the light guide,

Ns is the index of refraction of the medium outside the light guide, and
A is the angle from normal to the surface of the light guide

For air or another low index material, Ns would be 1.35 or less. For a plastic or glass light guide 21, Nlg might be 1.5. Angle A for these values is 64°.

If light strikes the surface of the light guide 21 at an angle greater than A, light will reflect off of the surface, in total internal reflection (TIR). The TIR light ray 36 continues to TIR reflect down the light guide 21 until it reaches a reflector film 40.

It should be noted that in FIG. 5, the taper of the light guide 21 is not evident, due to the close-up nature of the view. However, in the preferred embodiment, the thickness of the light guide 21 does indeed decrease from the end upon which the LEDs 22 are mounted to the distal end of the light guide 21, as shown in FIG. 3.

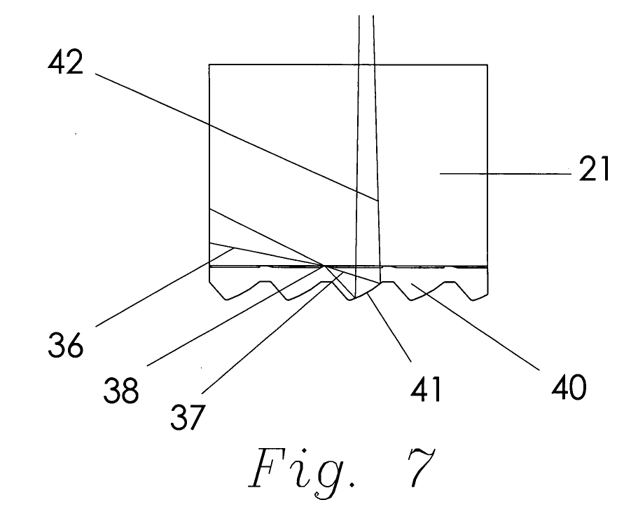

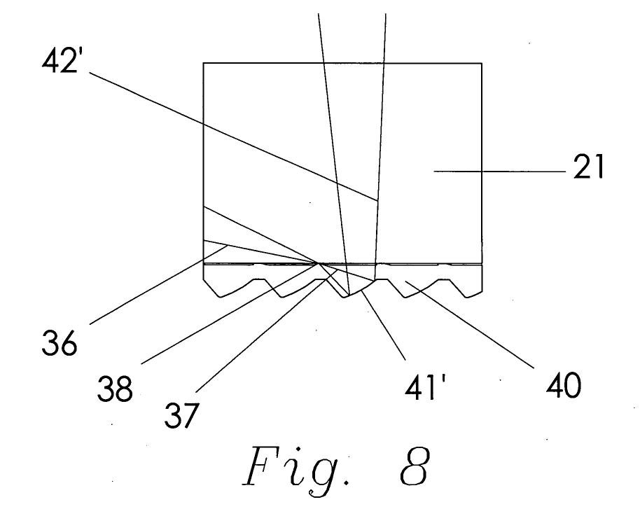

Referring now to FIGS. 5-7, the reflector film 40 comprises a plurality of discrete contact areas 38. Each contact area 38 is a discrete area of contact between the light guide 21 and the reflector film 40. The index of refraction of the reflector film 40 is preferably equal to or greater than the index of refraction of the light guide 21. FIG. 6 shows the TIR light ray 36 being slightly refracted as it enters the reflector film 40 as a refracted light ray 37. Due to the taper of the light guide 21, substantially all of the refracted light rays 37 eventually strike a reflector surface 41 of the reflector film 40. The reflector surfaces 41 of the reflector film 40 are constructed so that reflected light rays 42 are accurately directed to the LCD cell 23, and then eventually to the viewer.

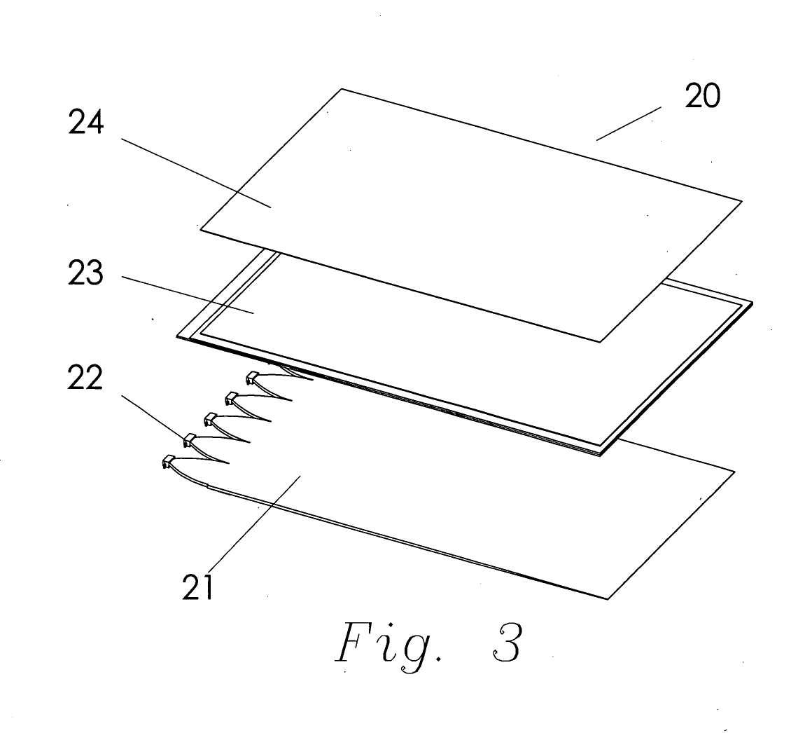

Referring now chiefly to FIG. 6, the reflected light ray 42 passes through the light guide 21, and then passes through a rear polarizing filter 50 of the LCD cell 23. The reflected light ray 42 continues into the LCD cell 23 through a rear glass 51. The reflected light ray 42 eventually reaches a top surface 52 of the rear glass 51. An LCD display matrix 53 is located on the top surface 52 of the rear glass 51. (The general structure of the LCD display matrix was disclosed in the prior art section above, with reference to FIG. 2.) The LCD display matrix 53 is a typical LCD display matrix of black areas that are designed to hide the controlling electronics of the display system. One skilled in the art of displays could envision any number of configurations of LCD displays and other display technologies that have a matrix within the display that would function effectively in the present invention. The reflected light rays 42 are focused by the reflector surfaces 41 to pass between the black areas that comprise the LCD display matrix 53. In the preferred embodiment, the reflected light rays 42 are directed to the black areas of the display matrix by making the pitch of the reflector surfaces 41 the same as the pitch of the display matrix of the system. The reflector surfaces 41 of the reflector film 40 must be properly aligned with the matrix 53 during assembly of the display system.

After the reflected light rays 42 pass through the LCD display matrix 53, the rays 42 continue through the front glass of the LCD cell 23. The reflected light rays 42 continue through the front polarizer 54 and on through the diffusion filter 24 to the viewer. The diffusion filter 24 diffuses the viewed light 43 in a controlled manner that is varied in accordance with the desired output of the display. The desired output is a function of the intended application of the display, and the structure of the diffusion filter 24 is varied accordingly.

The reflected light travels generally in a direction normal to the front polarizer 54 and the rear polarizer 50. The impingement of the light in a direction normal to the surface of the polarizing filters 50, 54 (as discussed above in the prior art section) allows the polarizers 50, 54 to be used to their maximum effect. The polarizing filters 50, 54 achieve their peak performance when light passes through them from an angle normal or nearly normal to their planar surfaces. The structure of the present invention therefore allows the system to function at peak efficiency.

An alternate configuration of the light guide assembly 1 is shown in FIG. 8, in which the reflector surfaces 41′ are constructed so as to not so tightly collimate the light to be focused toward the non-black areas of the display matrix 53. The advantages of avoiding the black matrix (increasing the brightness of the displayed light seen by the viewer) would be sacrificed in this alternate configuration. However, the advantages of accurate control of the angle of the output light and more efficient transmission of light are still realized.

In some applications where only a narrow viewing angle is required, another modification of the present invention can be employed. The diffusion filter 24 may be eliminated from the system for a further reduction in the thickness of the display and in manufacturing cost.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

I claim:

1. An optical display system comprising:
a light guide wherein light travels by total internal reflection,
at least one optical element that provides selective extraction of light from said light guide, and
a reflector element comprising a plurality of reflector surfaces, said reflector element being optically isolated from said light guide, said reflector element directing light out of said light guide in a predetermined direction and pattern through a display matrix; wherein
said display matrix comprises black areas and non-black areas, said reflector surfaces being aligned with said display matrix such that the light directed through said display matrix passes through said non-black areas of said display matrix, thereby increasing the brightness of an output of said display system.

2. The light guide system of claim 1 wherein:
elements of a light source of said system are mounted on a plurality of narrow mounting points on side reflector edges at a front end of said light guide, said mounting points being separated from each other, and
said side reflector edges expand in width from said mounting points to a base of said side reflector edges, said base of said side reflector edges being connected to a front end of a main body of said light guide.

3. The light guide system of claim 1 wherein:
said light guide decreases in thickness from an end of said light guide to which a light source is attached to an end of said light guide to which said reflector element is attached.

4. The optical display system of claim 1 wherein:
after light is directed from said light guide, the light passes through at least one diffusing element.

5. The optical display system of claim 1 wherein:
optical isolation of said light guide from said reflector element is accomplished by an air gap.

6. The light guide system of claim 1 wherein:
optical isolation of said light guide from said reflector element is accomplished by a thin layer of a material with a low index of refraction.

7. The light guide system of claim 1 wherein:
an index of refraction of said light guide is less than an index of refraction of said reflector element.

8. An optical display system comprising:
a light guide wherein light travels by total internal reflection,
at least one optical element that provides selective extraction of light from said light guide, and
a reflector element comprising a plurality of reflector surfaces, said reflector element being optically isolated from said light guide; wherein
elements of a light source of said system are mounted on a plurality of narrow mounting points on side reflector edges at a front end of said light guide, said mounting points being separated from each other, and
said side reflector edges expand in width from said mounting points to a base of said side reflector edges, said base of said side reflector edges being connected to a front end of a main body of said light guide.

9. The light guide system of claim 8 wherein:
said reflector element directs light out of said light guide in a predetermined direction and pattern through a display matrix, said display matrix comprising black areas and non-black areas, said reflector surfaces being aligned with said display matrix such that the light directed through said display matrix passes through said non-black areas of said display matrix, thereby increasing the brightness of an output of said display system.

10. The light guide system of claim 8 wherein:
said light guide decreases in thickness from an end of said light guide to which a light source is attached to an end of said light guide to which said reflector element is attached.

11. The optical display system of claim 8 wherein:
after light is directed from said light guide, the light passes through at least one diffusing element.

12. The optical display system of claim 8 wherein:
optical isolation of said light guide from said reflector element is accomplished by an air gap.

13. The light guide system of claim 8 wherein:
optical isolation of said light guide from said reflector element is accomplished by a thin layer of a material with a low index of refraction.

14. The light guide system of claim 8 wherein:
an index of refraction of said light guide is less than an index of refraction of said reflector element.

15. An optical display system comprising:
a light guide wherein light travels by total internal reflection,
at least one optical element that provides selective extraction of light from said light guide, and
a reflector element comprising a plurality of reflector surfaces, said reflector element being optically isolated from said light guide; wherein
said light guide decreases in thickness from an end of said light guide to which a light source is attached to an end of said light guide to which said reflector element is attached.

16. The light guide system of claim 15 wherein:
said reflector element directs light out of said light guide in a predetermined direction and pattern through a display matrix, said display matrix comprising black areas and non-black areas, said reflector surfaces being aligned with said display matrix such that the light directed through said display matrix passes through said non-black areas of said display matrix, thereby increasing the brightness of an output of said display system.

17. The light guide system of claim 15 wherein:
elements of a light source of said system are mounted on a plurality of narrow mounting points on side reflector edges at a front end of said light guide, said mounting points being separated from each other, and
said side reflector edges expand in width from said mounting points to a base of said side reflector edges, said base of said side reflector edges being connected to a front end of a main body of said light guide.

18. The optical display system of claim 15 wherein:
after light is directed from said light guide, the light passes through at least one diffusing element.

19. The optical display system of claim 15 wherein:
optical isolation of said light guide from said reflector element is accomplished by an air gap.

20. The light guide system of claim 15 wherein:
optical isolation of said light guide from said reflector element is accomplished by a thin layer of a material with a low index of refraction.

21. The light guide system of claim 15 wherein:
an index of refraction of said light guide is less than an index of refraction of said reflector element.

22. An optical display system comprising:
a light guide wherein light travels by total internal reflection,
at least one optical element that provides selective extraction of light from said light guide, and
a reflector element comprising a plurality of reflector surfaces, said reflector element being optically isolated from said light guide, said reflector element directing light out of said light guide in a predetermined direction and pattern through a display matrix; wherein
said display matrix comprises black areas and non-black areas, said reflector surfaces being aligned with said display matrix such that the light directed through said display matrix passes through said non-black areas of said display matrix, thereby increasing the brightness of an output of said display system, and
elements of a light source of said system are mounted on a plurality of narrow mounting points on side reflector edges at a front end of said light guide, said mounting points being separated from each other, and said side reflector edges expand in width from said mounting points to a base of said side reflector edges, said base of said side reflector edges being connected to a front end of a main body of said light guide, and
said light guide decreases in thickness from an end of said light guide to which a light source is attached to an end of said light guide to which said reflector element is attached.

23. The optical display system of claim 22 wherein:
after light is directed from said light guide, the light passes through at least one diffusing element.

24. The optical display system of claim 22 wherein:
optical isolation of said light guide from said reflector element is accomplished by an air gap.

25. The light guide system of claim 22 wherein:
optical isolation of said light guide from said reflector element is accomplished by a thin layer of a material with a low index of refraction.

26. The light guide system of claim 22 wherein:
an index of refraction of said light guide is less than an index of refraction of said reflector element.
